(19) United States
(12) Patent Application Publication
(10) Pub. No.: US 2020/0390120 A1
(43) Pub. Date: Dec. 17, 2020

(54) CHEESE HAVING SHEEP-LIKE AND/OR GOATY FLAVOUR ATTRIBUTES

(71) Applicant: CSK Food Enrichment B.V., Leeuwarden (NL)

(72) Inventors: Willem Cornelis Meijer, Bennekom (NL); Johannes Bernhard Brandsma, Leeuwarden (NL); Albertus Antonius Gerardus Hafkamp, Leuvenheim (NL)

(73) Assignee: CSK Food Enrichment B.V., Leeuwarden (NL)

(21) Appl. No.: 17/009,299

(22) Filed: Sep. 1, 2020

Related U.S. Application Data
(63) Continuation of application No. 14/901,205, filed on Dec. 28, 2015, now abandoned.

(30) Foreign Application Priority Data
Jul. 3, 2013 (EP) 13174881.6
Jul. 3, 2013 (EP) 13174885.7

(51) Int. Cl. A23C 19/032; A23C 19/04; A23C 9/12; A23C 19/14

(52) U.S. Cl. CPC A23C 19/0325; A23C 19/043; A23C 19/14; A23C 9/1206; A23C 9/1216; A23C 19/0323

(57) ABSTRACT

The present invention relates to a method for producing a cheese. The cheese has one or more flavour characteristics of a sheep cheese and/or a goat cheese. The method most preferably comprises mixing a milk with a coagulant, a starter culture, a strain of Yarrowia lipolytica and a strain of Kluyveromyces lactis, and wherein the milk comprises or consists of bovine milk having a milk fat content.

### CROSS-REFERENCE TO RELATED APPLICATIONS

This application is a continuation of U.S. patent application Ser. No. 14/901,205 filed Dec. 28, 2015, which is the U.S. National Stage of International Application No. PCT/NL2013/050865, filed Dec. 3, 2013, which claims the benefit of and priority to European Application Nos. 13174881.6, filed Jul. 3, 2013, and 13174885.7 filed Jul. 3, 2013, all of which are hereby incorporated by reference herein in their entireties.

### FIELD OF THE INVENTION

The present invention relates to a method for producing a cheese, especially a white brined cheese or a cheese of the semi-hard or hard type. The cheese preferably has one or more flavour characteristics of a sheep cheese and/or a goat cheese.

### BACKGROUND OF THE INVENTION

Ewe's and goat's milk cheeses have special tastes and flavours, very distinct from those of cheese made from cow's milk. These differences can be explained by compositional differences between the milk types. Southern European countries account for most of the production of ewe's and goat's milk cheese. The manufacture of many of them is regulated by a Protected Designation of Origin (PDO) at the national level, established mainly in Mediterranean countries.

To our best knowledge, in Spain, six PDO ewe's milk cheeses of the hard or semi-hard type are nowadays made: Manchego, Roncal, Idiazábal, Zamorano, La Serena and Torta del Casar. These cheeses and other ewe's or goat's milk PDO cheeses are described by M. Medina and M. Nunez in “CHEESE: Chemistry, Physics and Microbiology”, 3rd Edition, Vol. 2 (Major Cheese Groups), P. F. Fox et al. (Eds.), Elsevier, 2004, pp. 280-299.

Although pure goat's or sheep's milk cheeses are highly valued for their specific flavour and/or textural attributes, the greatly varying seasonal availability of said milk types has led cheese producers towards manufacturing blended milk cheese.

As a result, more than 50% of the cheese produced and eaten in Spain is made of blends of cow's, goat's and sheep's milks. The varying proportions used in the blend generally determine the cheese's attributes: taste, creaminess, body and texture. Cow's milk is the base ingredient of blended-milk cheeses, with goat's and sheep's milk being added in varying proportions according to the attributes desired in the final product.

The Ministry of Agriculture of Spain set regulations and quality standards to govern three types of blended-milk cheese: Hispánico, Ibérico and (De la) Mesta. All of these are of the semi-hard or hard type. These standards were implemented with legislation in July 1987 (Orden de 9 de julio de 1987 por la que se aprueban las normas de composición y caracteristicas especificas para los quesos «Hispánico», «Ibérico» y «De la Mesta», destinados al mercado interior (B.O.E. no. 170, 17 Jul. 1987, in particular Annex I-III; downloadable on the internet via http://www.boe.es/boe/dias/1987/07/17/pdfs/A21882-21885.pdf).

Hispánico cheese is made exclusively from sheep's milk (a minimum of 30% by volume) and cow's milk (a minimum of 50% by volume), with a minimum 55% of dry extract/ 45% fat content. Ibérico is made with a blend of three types of milk: cow's (a minimum of 50%), goat's (a minimum of 30%) and sheep's (a minimum of 10%). Dry extract and fat content/dry extract stipulations are similar to those of Hispánico. Mesta is made with ewe's milk (a minimum of 75%) cow's (a minimum of 15%) and optionally goat's (up to a maximum of 5%), with minimum dry extract at 55% and fat content/dry extract at a minimum of 50%, given the high natural fat content of ewe's milk.

The mix of different milks depends on various factors, and proportions also vary even with the season. Milk blending allows the skilled cheese maker to enhance and impart character in the flavor to approach what most consumers like and want. The rule of thumb in the art is the following: the more cow's milk it contains, the less complex the flavour profile of the cheese will be. Reference is made to http://www.cheesefromspain.com/CFS/134Tipos_M_I.htm. A disadvantage of milk blending is that if no further technical measures are taken, the cheese milk will always have to contain some ewe's and/or goat's milk to obtain the respective taste or flavour characteristics in a semi-hard or hard cheese.

Feta is another example of a cheese type which is traditionally or by denomination of origin made exclusively from ewe's milk or from a mixture of ewe's milk and goat's milk. Feta belongs to the class of brine-ripened cheese, also indicated as “white brined cheese” or “brined cheese”. For similar reasons related to raw material cost and availability indicated above, there is a trend for industrial producers of white brined cheese to at least partially replace ewe's milk with cow's milk. Brined cheese produced from cow milk with a starter containing Lactococcus lactis and Lactobacillus casei and a blend of kid and lamb pregastric esterases has been reported to develop a body, flavour and texture similar to those of authentic feta cheese, cf. P. F. Fox et al, Fundamentals of cheese science, Aspen Publishers Inc., 2000, Chapter 15, p. 335. Source of lipase can be an exogenous lipase such as a pregastric esterase, which is in an embodiment provided in the form of a rennet preparation such as a rennet paste. Alternatively the lipase may be obtained from fungal species such as R. miehei, R. pusillus or A. oryzae. A disadvantage of the method is that the Lactobacillus adjunct culture can contribute to acidification of the milk, which necessitates the cheese manufacturer to adapt the dose of the main starter.

NL 7607988 discloses a method to produce feta cheese from cow's milk in the presence of an added exogenous lipase (lamb's lipase) and a chlorophyll, the latter for discoloration of the milk. To the inventors' best knowledge, most if not all industrially produced feta-type cheese, packaged in glass jars under brine or in oil or sealed in a plastic foil, is based on cheese making methods using cow's milk and an exogenous lipase.

Disadvantages of prior art methods also relate to the taste of the resulting cheese, which apart from being “soapy” is usually rather bland and lacks the complexity of traditional feta made of ewe's milk.

Hence it is an object of the present invention to provide a method for producing a cheese which has one or more flavour characteristics of a sheep cheese and/or a goat cheese, and which does not have the disadvantages of prior art methods.

### SUMMARY OF THE INVENTION

In a first aspect, the present invention provides a method for producing (a.) a white brined cheese or (b.) a cheese having one or more flavour characteristics of a sheep cheese and/or of a goat cheese, said method comprising mixing milk with
a coagulant,
a starter culture,
an exogenous carboxylic ester hydrolase or more preferably a lipolytic yeast strain, and
an ethanol producing micro-organism which is preferably capable of metabolising lactose;
   wherein the milk comprises one or more milk types selected from the group consisting of bovine milk having a fat content, goat's milk having a fat content and ewe's milk having a fat content. In one embodiment, the present method is for producing a cheese having one or more flavour characteristics of a sheep cheese and/or of a goat cheese. In another embodiment the method is for producing a white brined cheese, wherein the white brined cheese preferably has one or more flavour characteristics of a sheep cheese and/or of a goat cheese. In a preferred embodiment of (b.), the present method is for producing a semi-hard or hard cheese having one or more flavour characteristics of a sheep cheese and/or of a goat cheese.

In one embodiment, the present invention provides a method for producing (a.) a white brined cheese or (b.) a cheese having one or more flavour characteristics of a sheep cheese and/or of a goat cheese, said method comprising mixing milk with
a coagulant,
a starter culture,
an exogenous carboxylic ester hydrolase or more preferably a lipolytic yeast strain, and
an ethanol producing micro-organism which is preferably capable of metabolising lactose;
   wherein the milk is predominantly provided as bovine milk having a fat content. In one embodiment, the present method is for producing a cheese having one or more flavour characteristics of a sheep cheese and/or of a goat cheese. In another embodiment the present method is for producing a white brined cheese, wherein the white brined cheese preferably has one or more flavour characteristics of a sheep cheese and/or of a goat cheese. In a preferred embodiment of (b.), the present method is for producing a semi-hard or hard cheese having one or more flavour characteristics of a sheep cheese and/or of a goat cheese. Accordingly, white brined cheese or cheese having one or more flavour characteristics of a sheep cheese and/or of a goat cheese, preferably semi-hard or hard cheese, can surprisingly be produced using bovine milk having a fat content, even if used as the predominant or only milk source, and without the mandatory use of lactic acid bacterial adjunct cultures, such as lactobacilli, which can interfere with the acidification process. In addition, it has been found that if the milk (further) comprises ewe's or goat's milk, the sheep-like or goaty flavour characteristics of the cheese are further enhanced and/or generated more quickly.

In an especially favored aspect, the present invention provides a method for producing (a.) a white brined cheese or (b.) a cheese having one or more flavour characteristics of a sheep cheese and/or of a goat cheese, said method comprising mixing milk with
a coagulant,
a starter culture,
a lipolytic yeast strain, and
an ethanol producing micro-organism which is preferably capable of metabolising lactose;
wherein the milk preferably has a lactose content and wherein the milk comprises one or more milk types selected from the group consisting of bovine milk having a fat content, goat's milk having a fat content and ewe's milk having a fat content.

Herein further preferably no exogenous carboxylic ester hydrolase is mixed with the milk. As exogenous enzymes may leak to the whey to a greater extent than a lipolytic yeast strain, the potential for whey valorization can be improved significantly if a lipolytic yeast strain is employed in addition to or in place of an exogenous carboxylic ester hydrolase. In one embodiment, the present method is for producing a cheese having one or more flavour characteristics of a sheep cheese and/or of a goat cheese. In another embodiment the present method is for producing a white brined cheese, wherein the white brined cheese preferably has one or more flavour characteristics of a sheep cheese and/or of a goat cheese. In a preferred embodiment of (b.), the present method is for producing a semi-hard or hard cheese having one or more flavour characteristics of a sheep cheese and/or of a goat cheese.

In one embodiment, the present invention provides a method for producing (a.) a white brined cheese or (b.) a cheese having one or more flavour characteristics of a sheep cheese and/or of a goat cheese, said method comprising mixing milk with
a coagulant,
a starter culture,
a lipolytic yeast strain, and
an ethanol producing micro-organism which is preferably capable of metabolising lactose;
wherein the milk preferably has a lactose content and wherein the milk is predominantly provided as bovine milk having a fat content.

Herein further preferably no exogenous carboxylic ester hydrolase is mixed with the milk. In one embodiment, the present method is for producing a cheese having one or more flavour characteristics of a sheep cheese and/or of a goat cheese. In another embodiment the present method is for producing a white brined cheese, wherein the white brined cheese preferably has one or more flavour characteristics of a sheep cheese and/or of a goat cheese. In a preferred embodiment of (b.), the present method is for producing a semi-hard or hard cheese having one or more flavour characteristics of a sheep cheese and/or of a goat cheese.

It is preferred that the milk has a lactose content, which is normally the case if the lactose naturally present in the animal's milk has not been removed or converted into monosaccharides. It is further preferred that the ethanol producing micro-organism is capable of metabolising lactose. As a consequence said ethanol producing micro-organism can conveniently grow in the milk without needing added carbon sources.

It is especially preferred that the ethanol producing micro-organism is an ethanol producing yeast strain. Accordingly a further improved flavour and/or taste of the cheese can be obtained. In the broadest sense of the invention, however, the ethanol producing micro-organism can be replaced by a source of ethanol, in the sense of any source of ethanol, including ethanol itself.

For the avoidance of doubt, in the embodiment wherein the ethanol producing micro-organism is an ethanol producing yeast strain, the lipolytic yeast strain and the ethanol producing yeast strain capable of metabolising lactose are preferably different yeast strains. In optional embodiments of the method, the milk can be mixed with one or more further yeast strains which may have the same or different properties as one or both of said yeast strains.

The method for producing cheese having one or more flavour characteristics of a sheep cheese and/or of a goat cheese as in embodiment (b.) preferably further comprises ripening the cheese. The cheese is preferably ripened for 2-52 weeks after its production, more preferably for 4-32 weeks after its production, such as for 4-16 or 4-8 weeks after its production.

The method for producing white brined cheese preferably further comprises ripening the cheese. The cheese is preferably ripened in brine for 1-356 days after its production, more preferably for 1-100 days after its production, such as for 1-10 days after its production. It is noted that the (accelerated) development of the sheep-like and/or goaty flavour notes can typically be perceived much more quickly, and for white brined cheese very quickly, usually within a day, depending on the type of cheese, the dosage of the ingredients and the processing conditions.

The invention further provides a use of
an exogenous carboxylic ester hydrolase or more preferably a lipolytic yeast strain; and
an ethanol producing micro-organism which is preferably capable of metabolising lactose,
   in a method for producing a cheese made at least partially, preferably predominantly, most preferably exclusively of bovine milk, preferably having a lactose content, and having a fat content, for generating in said cheese one or more flavour characteristics of a sheep cheese or a goat cheese.

The invention further provides a use of
a lipolytic yeast strain; and
an ethanol producing micro-organism which is preferably capable of metabolising lactose,
   preferably in the absence of an added exogenous carboxylic ester hydrolyase,
   in a method for producing a cheese made at least partially, preferably predominantly, most preferably exclusively of bovine milk, preferably having a lactose content, and having a fat content, for generating in said cheese one or more flavour characteristics of a sheep cheese or a goat cheese.

The invention further provides a use of
an exogenous carboxylic ester hydrolase or more preferably a lipolytic yeast strain; and
an ethanol producing micro-organism which is preferably capable of metabolising lactose,
   in a method for producing a cheese made of milk comprising goat's milk having a fat content and/or ewe's milk having a fat content, for accelerating the ripening of said cheese and/or for enhancing at least one of its goaty or sheep-like flavour characteristics. The milk preferably has a lactose content, preferably a lactose content between 0.5-10 wt. % relative to the weight of the milk.

The invention further provides a use of
a lipolytic yeast strain; and
an ethanol producing micro-organism which is preferably capable of metabolising lactose,
   preferably in the absence of an added exogenous carboxylic ester hydrolyase,
   in a method for producing a cheese made of milk comprising goat's milk having a fat content and/or ewe's milk having a fat content, for accelerating the ripening of said cheese and/or for enhancing at least one of its goaty or sheep-like flavour characteristics. The milk preferably has a lactose content, preferably a lactose content between 0.5-10 wt. % relative to the weight of the milk.

Said use, preferably the use for generating in a cheese one or more flavour characteristics of a sheep cheese or a goat cheese, is preferably for producing a ripened cheese. The cheese is preferably ripened for 2-52 weeks after its production, more preferably for 4-32 weeks after its production, such as for 4-16 or 4-8 weeks after its production. It is noted that the (accelerated) development of the sheep-like and/or goaty flavour notes can typically be perceived much more quickly, depending on the type of cheese, the dosage of the ingredients and the processing conditions.

Especially in embodiments wherein the ethanol producing micro-organism is an ethanol producing yeast strain, it is most preferred that no, or substantially no viable propionibacteria are added to the milk. Propionibacteria can generate propionic acid when grown on milk. Propionic acid is known to reduce or prevent the outgrowth of yeast strains or to even kill them. Especially the reduction or prevention of the outgrowth of the ethanol producing yeast strain has been found to have a negative effect on the development of sheep-like or goaty flavours in the cheese. Thus, preferably in the present method or use involving an embodiment wherein the ethanol producing micro-organism is an ethanol producing yeast strain, no propionibacteria are added to the milk in an amount that exceeds 1.10⁴ cfu (colony forming units) per ml of milk. Preferably the amount of propionibacteria that is added to the milk is less than 1.10² cfu, such as from 0-10 cfu, per ml of milk.

The invention further provides a frozen or dried yeast culture composition having a weight of at least 10 g, preferably contained in a closed container comprising
(i.) an exogenous carboxylic ester hydrolase or more preferably a lipolytic yeast strain; and
(ii.) an ethanol producing micro-organism which is preferably capable of metabolising lactose.

Herein the ethanol producing micro-organism is preferably an ethanol producing yeast strain which, further preferably, is capable of metabolizing lactose.

In a preferred embodiment, the invention further provides a frozen or dried yeast culture composition having a weight of at least 10 g, preferably contained in a closed container comprising
(i.) a lipolytic yeast strain; and
(ii.) an ethanol producing micro-organism which is preferably capable of metabolising lactose,
   and preferably no added exogenous carboxylic ester hydrolase. Herein the ethanol producing micro-organism is preferably an ethanol producing yeast strain which, further preferably, is capable of metabolizing lactose.

In a preferred embodiment, components (i.) and (ii.) are provided in such amounts and/or having such activities that the composition is suitable for generating, in a cheese made exclusively of bovine milk having a lactose content and a fat content, one or more flavour characteristics of a sheep cheese or a goat cheese.

In one embodiment, the invention provides a yeast culture composition comprising
(i.) an exogenous carboxylic ester hydrolase or more preferably a lipolytic yeast strain; and
(ii.) an ethanol producing micro-organism which is preferably capable of metabolising lactose,
   wherein components (i.) and (ii.) are provided in such amounts and/or having such activities that the composition is suitable for generating, in a cheese made exclusively of bovine milk having a lactose content and a fat content, one or more flavour characteristics of a sheep cheese or a goat cheese. Herein the ethanol producing micro-organism is preferably an ethanol producing yeast strain which, further preferably, is capable of metabolizing lactose. The yeast culture composition preferably is provided in frozen or dried form. The yeast culture composition preferably has a weight of at least 10 g. The yeast culture composition preferably is provided in a closed container.

The invention further provides a yeast culture composition comprising
(i.) a lipolytic yeast strain; and
(ii.) an ethanol producing micro-organism which is preferably capable of metabolising lactose,
   and preferably no added exogenous carboxylic ester hydrolase,
   wherein components (i.) and (ii.) are provided in such amounts and/or having such activities that the composition is suitable for generating, in a cheese made exclusively of bovine milk having a lactose content and a fat content, one or more flavour characteristics of a sheep cheese or a goat cheese. Herein the ethanol producing micro-organism is preferably an ethanol producing yeast strain which, further preferably, is capable of metabolizing lactose. The yeast culture composition preferably is provided in frozen or dried form. The yeast culture composition preferably has a weight of at least 10 g. The yeast culture composition preferably is provided in a closed container.

This suitability requirement, or the generation of one or more flavour characteristics of a sheep cheese or a goat cheese in a cheese produced from bovine milk only, can be verified experimentally by a tasting panel.

The skilled person will have no difficulty selecting suitable amounts and/or activities of components (i.) and (ii.). The ethanol producing micro-organism, in particular the ethanol producing yeast strain, is preferably capable of metabolizing lactose and is preferably present in an amount of 1.10⁸ cfu or higher, more preferably in an amount of 1.10⁹ cfu or higher, per gram of the composition. Component (i.) is suitably provided in amounts which are adequate to provide sufficient lipolytic activity.

Preferably, in the cheese making method wherein the ethanol producing micro-organism is an ethanol producing yeast strain and wherein the milk has a lactose content, preferably a lactose content of 0.5-10 wt. %, more preferably of 1-6 wt. % relative to the weight of the milk, the ratio of the inoculation rate of the lipolytic yeast strain over the inoculation rate of the ethanol producing yeast strain preferably capable of metabolising lactose is greater than 1:6, more preferably greater than 1:4, most preferably greater than 1:2; herein it is further preferred that the ratio of the inoculation rate of the lipolytic yeast strain over the inoculation rate of the ethanol producing yeast strain capable of metabolising lactose is lower than 10:1, more preferably lower than 6:1, more preferably lower than 4:1, most preferably lower than 2:1. Especially if no exogenous ester hydrolase is present or added and if the ethanol producing micro-organism is an ethanol producing yeast strain, it is especially preferred that in the cheese making method the inoculation rate of the lipolytic yeast strain (expressed in colony forming units of the strain per ml of milk) is equal to or higher than the inoculation rate of the ethanol producing yeast strain capable of metabolising lactose. Providing a relatively high inoculation rate of the lipolytic yeast strain is a convenient way to provide sufficient lipolytic activity which is needed to achieve the desired flavour profile. However it is possible to generate sufficient lipolytic activity in other ways, for example by selecting e.g. using high throughput screening techniques a yeast strain having a high lipolytic activity, or by overexpressing lipolytic activity in a wild type yeast strain, by using conventional genetic modification techniques. Most preferably however, each of the micro-organisms defined herein, and particularly preferably each of the yeast strains defined herein are non-genetically modified organisms (GMOs). Preferably, therefore, each of the micro-organisms or yeast strains defined herein has not been subjected to targeted insertion of foreign DNA. The micro-organisms or yeast strains defined herein most preferably do not contain foreign genes coding for production of one of more enzymes, said one or more enzymes being preferably selected from the group consisting of enzymes having milk clotting activity and enzymes conferring antibiotic resistance activity or enhanced antibiotic resistance to the micro-organism.

The invention thus preferably provides a frozen or dried yeast culture composition having a weight of at least 10 g, preferably contained in a closed container comprising
(i.) a lipolytic yeast strain; and
(ii.) an ethanol producing micro-organism which is preferably capable of metabolising lactose,
   wherein each of the lipolytic yeast strain and the ethanol producing micro-organism are preferably present in an amount of 1.10⁸ cfu or higher, more preferably in an amount of 1.10⁹ cfu or higher, per gram of the yeast culture composition; and
   wherein a ratio r can be defined as the total number of colony forming units of the lipolytic yeast strain divided by the total number of colony forming units of the ethanol producing micro-organism, wherein said ratio r is greater than 1:6, more preferably greater than 1:4, most preferably greater than 1:2. Further preferably said ratio r is lower than 10:1, more preferably lower than 6:1, more preferably lower than 4:1, most preferably lower than 2:1,
   wherein preferably the composition comprises no added exogenous carboxylic ester hydrolase.

Herein the ethanol producing micro-organism is preferably an ethanol producing yeast strain which, further preferably, is capable of metabolizing lactose.

Examples of ethanol producing micro-organisms suitable to be employed according to the present invention are micro-organisms selected from the group consisting of Leuconostoc and Lactobacillus fermentum.

As further elaborated below, in principle, a strain of Yarrowia hpolytica is a preferred species of the lipolytic yeast strain and a strain of Kluyveromyces lactis is a preferred species of the ethanol producing yeast strain capable of metabolising lactose. Incidentally, De Freitas et al., in International Journal of Food Microbiology 129 (2009) 37-42 teach a method for producing a Cantalet cheese using cow's milk in the presence of a strain of Yarrowia hpolytica and a strain of Kluyveromyces lactis. However in De Freitas, the strain of Yarrowia has been grown on a medium comprising a relatively high concentration concentration of glucose. The present inventors have established that growing a strain of Yarrowia hpolytica on a medium comprising added glucose at around 5 g/l yields a strain having much reduced lipolytic activity (per cell) as compared to the same yeast strain grown on a medium not containing added glucose. In addition, De Freitas et al. employ relative inoculation rates of Yarrowia hpolytica and of Kluyveromyces lactis ranging between 1:8-1:10. Given the growth conditions of the strain of Yarrowia hpolytica and of the relative inoculation rates (Kluyveromyces lactis being dominant) and as experimentally verified by the present inventors in a model system producing white brined cheese, the present inventors established that the above-mentioned yeast strain combination disclosed by De Freitas is not suitable to generate a sheep-like or goaty flavour in a cheese produced from bovine milk only. Indeed De Freitas et al. are silent regarding goaty or sheep-like flavour characteristics of the cheese produced in their studies.

Preferably the yeast culture composition comprises no propionibacteria at a viable cell count density exceeding 1.10⁶ cfu, preferably 1.10⁴ cfu per g of the yeast culture composition. Preferably propionibacteria are absent in the yeast culture composition.

The method for producing cheese preferably further comprises ripening the cheese. The cheese is preferably ripened for 2-52 weeks after its production, more preferably for 4-32 weeks after its production, such as for 4-16 or 4-8 weeks after its production.

The invention further provides a cheese having one or more flavour characteristics of a sheep cheese and/or of a goat cheese obtainable by the method of the present invention.

The invention further provides a white brined cheese obtainable by the method of the present invention.

Preferably the present cheese comprises
an exogenous carboxylic ester hydrolase, or preferably, a lipolytic yeast strain or DNA material originating from and characteristic for said yeast strain, and
an ethanol producing micro-organism which is preferably capable of metabolizing lactose, or DNA material originating from and characteristic for said yeast strain,
   and the cheese has been preferably produced using a milk source comprising more than 90% (v/v) of bovine milk and comprising less than 5% (v/v) of each of sheep's milk and goat's milk. Herein the ethanol producing micro-organism is preferably an ethanol producing yeast strain, which, further preferably, is capable of metabolizing lactose.

Preferably in the cheese obtainable by the method according to the invention the lipolytic yeast strain and the ethanol producing micro-organism are non-viable. Most preferably the cheese has been produced using bovine milk as the only milk source. The cheese is preferably ripened for 2-52 weeks after its production, more preferably for 4-32 weeks after its production, such as for 4-16 or 4-8 weeks after its production.

In a further embodiment, the present invention provides a method for producing a white brined cheese comprising mixing milk with
a coagulant,
a starter culture, and
a yeast culture composition comprising a strain of Yarrowia lipolytica and
an ethanol producing micro-organism which is preferably capable of metabolising lactose;
   wherein the milk comprises one or more milk types selected from the group consisting of bovine milk having a fat content, goat's milk having a fat content and ewe's milk having a fat content. Herein the milk preferably comprises bovine milk having a fat content. Alternatively or preferably additionally, no exogenous carboxylic ester hydrolase is mixed with the milk.

Herein, it is especially preferred if the ethanol producing micro-organism is an ethanol producing yeast strain. The ethanol producing yeast strain is preferably capable of metabolizing lactose. The strain of Yarrowia lipolytica and the ethanol producing micro-organism can be added together to the milk, e.g. as a mixed composition, or they can be added separately to the milk. The white brined cheese preferably has one or more flavour characteristics of a traditional feta cheese made of ewe's milk or of a mixture of ewe's milk and goat's milk.

The invention further provides a use of a strain of Yarrowia lipolytica and an ethanol producing micro-organism in a method for producing a white brined cheese made at least partially, preferably predominantly, most preferably exclusively of bovine milk having a fat content, for generating in said cheese one or more flavour characteristics of a sheep cheese or a goat cheese, more preferably for generating in said cheese one or more flavour characteristics of a traditional feta cheese made of ewe's milk or of a mixture of ewe's milk and goat's milk. In said use preferably no exogenous carboxylic ester hydrolase is employed. The bovine milk preferably has a lactose content and the ethanol producing micro-organism herein is preferably capable of metabolizing lactose. The ethanol producing micro-organism herein is most preferably an ethanol producing yeast strain capable of metabolizing lactose.

The invention further provides a use of a strain of Yarrowia lipolytica and further an ethanol producing micro-organism in a method for producing a cheese made of milk comprising goat's milk having a fat content and/or ewe's milk having a fat content for accelerating the ripening of said cheese and/or for enhancing at least one of its goaty or sheep-like flavour characteristics.

The invention further provides a frozen or dried yeast culture composition having a weight of at least 10 g, preferably contained in a closed container comprising
(i.) a strain of Yarrowia lipolytica; and
(ii.) an ethanol producing micro-organism, preferably an ethanol producing yeast strain, which is capable of metabolising lactose,
   wherein each of the Yarrowia lipolytica and the ethanol producing micro-organism are preferably present in an amount of 1.10⁸ cfu or higher, more preferably in an amount of 1.10⁹ cfu or higher, per gram of the yeast culture composition.

Preferably a ratio r can be defined as the total number of colony forming units of the Yarrowia lipolytica divided by the total number of colony forming units of the ethanol producing micro-organism, wherein said ratio r is greater than 1:6, more preferably greater than 1:4, most preferably greater than 1:2. Further preferably said ratio r is lower than 10:1, more preferably lower than 6:1, more preferably lower than 4:1, most preferably lower than 2:1.

### DETAILED DESCRIPTION OF THE INVENTION

### Definitions

In the present context, the term “cheese” includes a product prepared by contacting optionally acidified milk (e.g. by means of a lactic acid bacterial culture) with a coagulant, and draining the resultant curd. The term “cheese” encompasses preferably, but not exclusively, fresh cheese, white brined cheese, semi-hard cheese and hard cheese. Fresh cheese includes quark, cream cheese and cottage cheese.

The term “starter culture” relates to any bacterial culture that is suitable for use in milk acidification, and preferably comprises lactic acid bacteria. The term preferably comprises a strain of a genus selected from the group consisting of Lactococcus, Lactobacillus, Micrococcus, Leuconostoc, Pediococcus, Streptococcus and Enterococcus.

The term “coagulant” is known to the skilled person and preferably relates to a milk clotting enzyme or to an acid capable of lowering the pH of milk, when added thereto, to pH values of 4.6 or lower or to a mixture thereof. In the context to the present invention the term “coagulant” preferably relates to a milk clotting enzyme. The coagulant is preferably used in conjunction with a calcium or magnesium salt which can be added to the milk together with the coagulant or separately from the coagulant. The milk clotting enzyme is preferably provided in the form of animal abomasal rennet, such as calf rennet (commercially available e.g. as Kalase®, ex CSK Food Enrichment BV, The Netherlands) or as microbial rennet preferably derived or obtained from Mucor miehei, Pusillus or other fungal species (commercially available e.g. as Milase®, ex CSK Food Enrichment BV, The Netherlands) or as a mixture thereof. Additionally or alternatively the milk clotting enzyme may be provided in the form of a fermentation produced chymosin, which is commercially available e.g. as Chymax® (Chr Hansen A/S, Denmark), or as a plant derived proteinase such as an extract from a cardoon thistle. Advantageously the coagulant comprises a rennet selected from the group consisting of animal rennet and microbial rennet.

The term “milk” is known to the skilled person and preferably relates to a composition comprising, or preferably consisting of, a lacteal secretion from an animal species. The milk may be raw or processed, e.g. by filtering, sterilizing, pasteurizing, homogenizing etc, or it may be reconstituted dried milk. The milk may be full fat milk or alternatively partially skimmed. Preferably the milk before it is mixed with the other ingredients has a lactose content of between 0.5-10 wt. % relative to the weight of the milk, further preferably said milk has a natural or not chemically modified lactose content of the milk or the milk blend. An important example of “milk” according to the present invention is pasteurized milk. It is understood that the milk may be acidified, mixed or processed before, during and/or after the adding of bacterial cultures. “bovine milk” relates to a composition comprising a lacteal secretion obtained from an animal species belonging to the subfamily Bovinae (which includes the domestic cow (Bos taurus) and buffalo). Bovine milk preferably comprises milk obtained from Bos Taurus or, equivalently, cow's milk.

In embodiments wherein the ethanol producing micro-organism is an ethanol producing yeast strain, the milk preferably has an oxygen content before it is mixed with the ethanol producing yeast strain. Accordingly an optimal ethanol production can be achieved. Conveniently and preferably, the milk is thereto provided as is and/or is not submitted to a degassing step.

The expression “wherein the milk comprises one or more milk types selected from the group consisting of bovine milk having a fat content, goat's milk having a fat content and ewe's milk having a fat content” preferably comprises the following embodiments: the milk is preferably obtained or obtainable by providing bovine milk having a fat content, by providing a mixture comprising bovine milk having a fat content and ewe's milk optionally having a fat content, by providing a mixture comprising bovine milk optionally having a fat content and ewe's milk having a fat content, by providing a mixture comprising bovine milk having a fat content and goat's milk optionally having a fat content, by providing a mixture comprising bovine milk optionally having a fat content and goat's milk having a fat content, by providing a mixture comprising ewe's milk having a fat content and goat's milk optionally having a fat content, by providing a mixture comprising ewe's milk optionally having a fat content and goat's milk having a fat content or by providing a mixture comprising bovine milk, goat's milk and ewe's milk wherein at least one—or more preferably each—of said milk types comprises a fat content. The milk may optionally further contain up to 50% (v/v) more preferably up to 30% (v/v) or most preferably up to 10% (v/v) in total of other types of milk. Preferably the milk comprises at least 70%, more preferably at least 90% (v/v) such as 100% (v/v) bovine milk, goat's milk or ewe's milk or a mixture of two or three of said milk types.

In the expression “bovine milk having a fat content”, the fat comprises milk fat naturally occurring in bovine milk. Most preferably the expression “bovine milk having a fat content” relates to bovine milk comprising natural bovine milk fat in an amount of 0.25-10 wt. %, more preferably of 0.5-5 wt. % relative to the weight of the milk.

In the expression “goat's milk having a fat content”, the fat comprises milk fat naturally occurring in goat's milk. Most preferably the expression “goat's milk having a fat content” relates to goat's milk comprising natural goat's milk fat in an amount of 0.25-10 wt. %, more preferably of 0.5-5 wt. % relative to the weight of the milk.

In the expression “sheep's milk having a fat content”, the fat comprises milk fat naturally occurring in sheep's milk. Most preferably the expression “sheep's milk having a fat content” relates to sheep's milk comprising natural sheep's milk fat in an amount of 0.25-10 wt. %, more preferably of 0.5-5 wt. % relative to the weight of the milk.

The expression “carboxylic ester hydrolase” is known to the skilled person and comprises one or more hydrolases selected from the group consisting of enzymes belonging to the class EC 3.1.1. Preferably the expression “carboxylic ester hydrolase” relates to an esterase preferably belonging to class EC 3.1.1.1, to an arylesterase preferably belonging to class EC 3.1.1.2, or to a lipase preferably belonging to class EC 3.1.1.3.

The words “sheep” and “ewe” may be used interchangeably within the context of the present invention.

The skilled person knows how to establish whether a cheese has “one or more flavour characteristics of a sheep cheese and/or of a goat cheese.” This is especially straightforward in a method for producing a cheese made of milk comprising goat's milk having a fat content and/or ewe's milk having a fat content, for example to assess whether one ore more goaty or sheep-like flavours are enhanced or if ripening has accelerated, since a direct comparison can be made in the absence of (i.) the exogenous carboxylic ester hydrolase or preferably the lipolytic yeast strain and (ii.) the ethanol producing micro-organism, preferably the ethanol producing yeast strain.

In the assessment of a cheese made exclusively of bovine milk having a fat content, preferably an expert panel of 6-10 members is trained to recognize goat-like flavours and/or sheep-like flavours in one or more cheeses made of goat's and/or ewe's milk which in terms of type of cheese, production protocol, fat content, moisture content, salt content, and age/ripening time are comparable to the cow's milk cheese to be assessed. The panel is then asked to rate the cheese made of cow's milk as having sheep-like flavours or goaty flavours; samples are evaluated for tasting not, a little, moderately or a lot like goat cheese and even exceeding the taste of goat cheese, and for tasting not, a little, a lot like sheep cheese and even exceeding the taste of sheep cheese.

The expression ‘white brined cheese” is known to the skilled person and comprises the terms “white cheese” or “brined cheese”. White brined cheese is a rindless cheese which has been ripened in a brine solution. White brine cheese is preferably packaged in a closed foil material or in a container whilst at least part of the surface of the white brined cheese is in contact with a brine solution typically comprising 2-20 wt. %, more preferably 4-12 wt. % of sodium chloride relative to the weight of the brine solution. The surface of white-brined cheese is thus preferably at least partly in contact with a brine solution, wherein said brine solution preferably comprises 2-20 wt. %, more preferably 4-12 wt. % of sodium chloride relative to the weight of the brine solution. Although it is manufactured in various shapes and sizes, white brined cheese preferably has a block shape. White brined cheese is preferably provided as pieces each having a weight of between 1 g and 3 kg. White brined cheese preferably has a moisture content of 40-65 wt. % most preferably of 46-60 wt. % relative to the total weight of the cheese. Typical and preferred examples of white brined cheese include Feta, Teleme, Brinza, Bli-sir-U-kriskama, Bjalo Samureno sirene (or Belo Samureno sirene), Chanakh, Beyaz peynir, Akawi, Baida, Iranian white cheese, Domiati, Dani, Gibna bayda, Halloumi, Braided Meddafara, Magdula and Nabulsi, or analogues thereof made of any type of milk comprising cow's milk.

The expression “semi-hard cheese” is known to the skilled person and preferably relates to a cheese having a water content of between 33-60 wt. % more preferably having a water content of 33-50% most preferably having a water content of 33-45%. The surface of a ripened or ready-to-eat semi-hard cheese is preferably substantially dry; additionally or alternatively the surface of a ripened or ready-to-eat semi-hard cheese is preferably substantially not in contact with a brine solution. The expression “semi-hard cheese” comprises a Gouda-type cheese and a Cheddar-type cheese.

The expression “hard cheese” is known by the skilled person and preferably relates to a cheese having a water content of less than 33 wt %, such as from 20-33 wt. %. The surface of a ripened or ready-to-eat hard cheese is preferably substantially dry; additionally or alternatively the surface of a ripened or ready-to-eat hard cheese is preferably substantially not in contact with a brine solution. The expression “hard cheese” comprises Emmental and Parmesan. The expression “hard cheese” preferably relates to a cheese selected from the group consisting of Emmental, Parmesan, Grana, Goya, Pecorino and Romano. The expression “hard cheese” most preferably relates to a cheese selected from the group consisting of Parmesan, Grana, Goya, Pecorino and Romano. Romano herein includes Pecorino Romano.

The expression “semi-hard or hard cheese” therefore preferably relates to a ripened or ready-to-eat cheese having a water content of 20-60 wt. % even more preferably having a water content of 20-50 wt. % most preferably having a water content of 25-45 wt. %, the surface of which is substantially dry or is substantially not in contact with a brine solution. This cheese is preferably a pressed cheese.

A Gouda-type cheese is known as such by the skilled person and within the present context preferably relates to a cheese which is salted after pressing, preferably in a brine and which is subsequently ripened. The brine preferably comprises at least 16 wt. % sodium chloride. Preferably, after brining and before, during and/or after ripening the surface of the cheese is brought in direct contact with a plastic foil, with a wax-like material or with a coating material typically comprising a polyester-based (co)polymer. Thus, the surface of a Gouda-type cheese preferably comprises a plastic foil, a wax-like material or a coating material typically comprising a polyester-based (co)polymer applied thereto. Ripening time is preferably at least 14 days and preferably at most 3 years. The surface of a ripened Gouda-type cheese is preferably substantially dry; additionally or alternatively the surface of a ripened Gouda-type cheese is preferably substantially not in contact with a brine solution. Preferably a Gouda-type cheese has a water content of 34-57 wt. % relative to the total weight of the cheese. A Gouda-type cheese preferably has a weight of between 5-90 kg. A Gouda-type cheese preferably comprises one or more strains of Lactococcus lactis subsp. or DNA material originating from said one or more strains of Lactococcus lactis subsp, and preferably further one or more strains of Leuconostoc subsp or DNA material originating from said one or more strains of Leuconostoc subsp. A Gouda-type cheese preferably has a fat-in-dry-matter content of 5-60%, more preferably 20-50%. A Gouda-type cheese preferably has a water-in-fat-free-matter content of 40-70%, more preferably 50-65%. A Gouda-type cheese is preferably selected from the group consisting of Gouda, Edam, and Tilsit. A Maasdam or Emmental type cheese is preferably outside the scope of the present invention. More generally, any type of cheese comprising eyes whose formation has been mediated by inter alia propionic acid bacteria is preferably outside the scope of the present invention.

A Cheddar-type cheese is known as such by the skilled person and within the present context preferably relates to a cheese which is salted before pressing and which after pressing is ripened. Preferably, before, during and/or after ripening, the surface of the cheese is brought in direct contact with a plastic foil, with a wax-like material or with a coating material typically comprising a polyester-based (co)polymer. Thus, the surface of a Cheddar-type cheese preferably comprises a plastic foil, a wax-like material or a coating material typically comprising a polyester-based (co)polymer applied thereto. Ripening time is preferably at least 14 days and preferably at most 3 years. The surface of a ripened Cheddar-type cheese is preferably substantially dry; additionally or alternatively the surface of a ripened Cheddar-type cheese is preferably substantially not in contact with a brine solution. Cheddar-type cheese preferably has a water content of 33-50 wt. %, more preferably of 34-42 wt. % relative to the total weight of the cheese. A Cheddar-type cheese preferably has a weight of 5-90 kg. A Cheddar-type cheese preferably has a fat-in-dry-matter content of 5-60%, more preferably 20-60%.

The expression “2E9” means “2.10⁹” (two times ten to the power of nine, i.e. two thousand millions) etcetera.

The expression “brine” is defined herein as an aqueous solution comprising one or more inorganic salts selected from the group consisting of sodium chloride, calcium chloride and potassium chloride, wherein the total concentration of said one or more inorganic salts in the aqueous solution preferably ranges between 1-25 wt. % relative to the weight of the aqueous solution. In embodiments relating to the white brined cheese, the total concentration of said one or more inorganic salts in the aqueous solution is preferably between 3-12% relative to the weight of the aqueous solution.

The expression “an ethanol producing micro-organism” relates to a micro-organism which is capable of utilizing a carbon source for its metabolism and thereby generating ethanol. The expression “an ethanol producing yeast” relates to a yeast strain which is capable of utilizing a carbon source for its metabolism and thereby generating ethanol. The expression “an ethanol producing micro-organism capable of metabolising lactose” relates to a micro-organism which is capable of utilizing lactose for its metabolism and thereby generating ethanol. The expression “an ethanol producing yeast strain capable of metabolising lactose” relates to a yeast strain which is capable of utilizing lactose for its metabolism and thereby generating ethanol.

Unless otherwise indicated herein the expression “(total) viable cell count” relates to “(total) viable cell count density” which is preferably expressed in colony forming units (cfu) per gram or per ml. The (total) viable cell count of a strain in a culture or in a cheese is preferably expressed as cfu per gram of the culture or of the cheese, respectively. The (total) viable cell count of a strain in a milk, in the present context after being added to the milk, is preferably expressed as cfu per ml of milk.

Unless otherwise indicated the expression “a” or “an” herein relates to “one or more”. The terms “comprising”, “having”, “including” and “containing” are to be construed as open-ended terms (i.e., meaning “including, but not limited to,”) unless explicitly noted otherwise. The term “consisting of” is to be construed as “included and limited to”. Recitation of ranges of values herein are merely intended to serve as a shorthand method of referring individually to each separate value falling within the range, unless otherwise indicated herein, and each separate value is incorporated into the specification as if it were individually recited herein.

Unless otherwise indicated, all micro-organisms claimed or described herein, especially the strain of Yarrowia lipolytica and the ethanol-producing micro-organism, are preferably wild type strains. Further preferably, the wild type strains are naturally occurring in or on plants or on milk or on foodstuffs such as cheese, butter, yoghurt and margarine. Said micro-organisms may alternatively comprise mutants of said wild type strains. The term “mutants” encompasses wild type strains having alterations in their genome which are the result of mutations which have been caused by the action of biological, physical or chemical mutagens. Each of the terms mutants and mutagens is known by the skilled person. Herein, physical mutagens are preferably selected from the group consisting of light, especially UV light, and ionizing radiation. Chemical mutagens are preferably selected as one or more compounds selected from the group of reactive oxygen species (preferably peroxides), alkylating reagents (preferably methylnitronitrosoguanidine), and DNA intercalating agents. Biological mutagens are preferably selected as transposons, viruses, phages, or bacteria capable of causing inflammations such as Helicobacter pylori.

The expression “mutations which have been caused by the action of biological, physical or chemical mutagens” preferably excludes targeted insertion of foreign DNA, more preferably excludes targeted insertion of foreign DNA coding for enzyme activity relating to
milk clotting activity, or to
the ability to break down (e.g. to hydrolyse) antibiotics, or to
the ability to increase the antibiotic resistance of the host micro-organism by other means.

Herein the term “antibiotics” is known to the skilled person and preferably relates to therapeutically useful compounds having antimicrobial activity. The term “antibiotic resistance” is also known to the skilled person and preferably relates to the ability to grow or survive in the presence of therapeutically useful compounds having antimicrobial activity.

All micro-organisms claimed or described herein, especially the strain of Yarrowia lipolytica and the ethanol-producing micro-organism, are preferably non-GM micro-organisms. The term “non-GM” or “non-genetically modified” is known to the skilled person and preferably means that the micro-organism has not been subjected to targeted insertion of foreign DNA.

A non-GM micro-organism most preferably does not contain foreign genes coding for production of one of more enzymes, said one or more enzymes being preferably selected from the group consisting of enzymes having milk clotting activity and enzymes conferring antibiotic resistance activity or enhanced antibiotic resistance to the micro-organism.

### Deposited Microbial Organisms [Expert Solution]

Yarrowia lipolytica Strain CSK1795.

A sample of Yarrowia lipolytica strain CSK1795 has been deposited by the applicant at the Belgian Coordinated Collections of Micro-organisms (BCCM/THEM, Biomedical Fungi and Yeasts Collection, Scientific Institute of Public Health—Louis Pasteur, Mycology Section, Rue J. Wytsmanstraat 14, B-1050 Brussels, Belgium) under the accession number IHEM 26011 with a deposit date of 7 May 2013. The deposit has been made under the conditions of the Budapest Treaty on the International Recognition of the Deposit of Microorganisms for the Purposes of Patent Procedure.

Throughout the present description, the terms “CSK1795” and “IHEM 26011” may be used interchangeably.

Kluyveromyces lactis Strain CSK1407.

A sample of Kluyveromyces lactis strain CSK1407 has been deposited by the applicant at the Belgian Coordinated Collections of Micro-organisms (BCCM/IHEM, Biomedical Fungi and Yeasts Collection, Scientific Institute of Public Health—Louis Pasteur, Mycology Section, Rue J. Wytsmanstraat 14, B-1050 Brussels, Belgium) under the accession number IHEM 26012 with a deposit date of 7 May 2013. The deposit has been made under the conditions of the Budapest Treaty on the International Recognition of the Deposit of Microorganisms for the Purposes of Patent Procedure.

Throughout the present description, the terms “CSK1407” and “IHEM 26012” may be used interchangeably.

The Applicant requests that a sample of the deposited microorganisms will be made available only by the issue of a sample to an expert.

### General Preferred Embodiments of the Method or Where Applicable of the Use

The ethanol producing micro-organism is preferably selected from the group consisting of Leuconostoc, and Lactobacillus fermentum, and an ethanol producing yeast strain which is preferably capable of metabolising lactose. It is preferred that the ethanol producing micro-organism is an ethanol producing yeast strain. The ethanol producing yeast strain is preferably a strain of Kluyveromyces. It is especially preferred that the lipolytic yeast strain is a strain of Yarrowia hpolytica and that the ethanol producing yeast strain is a strain of Kluyveromyces. A strain of Kluyveromyces is capable of utilizing lactose for its metabolism and thereby generating ethanol. In case a strain of Kluyveromyces is present or employed, the inoculation rate of the milk with the strain of Yarrowia hpolytica is preferably equal to or higher than the inoculation rate of the milk with the strain of Kluyveromyces subsp. Accordingly a most balanced taste profile can be obtained. It has been found that if Kluyveromyces subsp. is too dominant, the cheese tastes too alcoholic or too much of brewer's yeast whilst if only Yarrowia hpolytica is too dominant the taste of the cheese will be mainly soapy and not typically goaty or sheep-like. The strain of Kluyveromyces is preferably selected from the group consisting of Kluyveromyces lactis and Kluyveromyces marxianus.

In an embodiment, in case the ethanol producing yeast strain is a strain of Kluyveromyces, the milk is optionally further mixed with Hafnia alvei with the proviso that the inoculation rate of Hafnia alvei does not exceed the total inoculation rate of Kluyveromyces, preferably by a factor of 2, more preferably by a factor of 5 or most preferably by a factor of 10. In another embodiment, preferably if the ethanol producing yeast strain is a strain of Kluyveromyces lactis, the milk is optionally further mixed with Hafnia alvei with the proviso that the inoculation rate of Hafnia alvei does not exceed the inoculation rate of Kluyveromyces lactis, preferably by a factor of 2, more preferably by a factor of 5 or most preferably by a factor of 10. In another and especially preferred embodiment the milk is not inoculated with a strain of Hafnia alvei.

### The Milk and the Fat Content of the Milk

The total amount of fat comprised by the cheese is preferably for at least 25% (wt./wt.) provided by milk fat from bovine milk, especially by milk fat from cow's milk.

In a preferred embodiment, the milk comprises bovine milk having a fat content and goat's milk having a fat content, wherein the milk comprises less than 30% (v/v), more preferably less than 10% of another milk type. Alternatively, and preferably, the milk comprises cow's milk having a fat content and sheep's milk having a fat content, wherein the milk comprises less than 30% (v/v), more preferably less than 10% (v/v) of another milk type. Herein each of the milks provided preferably has a natural lactose content. The lactose content can be optionally modified, e.g. lactose can be added or removed. A lactose content of between 0.5-10 wt. % is preferred. In one embodiment, each of the milks provided has a lactose content of between 0.5-10 wt. % or comprises a natural lactose content.

### The Starter Culture

In a preferred embodiment of the method, the starter culture comprises lactococci, especially one or more strains selected from the group consisting of Lactococcus lactis subsp. lactis and Lactococcus lactis subsp. cremoris. In a further preferred embodiment of the method, preferably of the method of producing a cheese having one or more flavour characteristics of a sheep cheese and/or of a goat cheese, to the milk lactobacilli are added, wherein the lactobacilli preferably comprise a strain of Lactobacillus helveticus. Lactobacilli are conveniently added in the form of an adjunct culture comprising said species.

The starter culture preferably comprises one or more lactococci capable of producing one or more class I type bacteriocins, which bacteriocins are preferably selected from the group consisting of a nisin and a lacticin.

Alternatively or more preferably additionally to lactococci the starter culture comprises one or more strains of Streptococcus salivarius subsp. thermophilus.

The addition of strains of Lactobacillus helveticus to the milk has been found to add an additional sweetness to the cheese which in combination with the lipolytic notes already present adds especially to the sheep-like character of the cheese. However the addition of strains of Lactobacillus helveticus generally improves the taste of the cheese, especially of a semi-hard or hard cheese. The use of class I type bacteriocins, especially in combination with an added strain of Lactobacillus helveticus, may contribute to accelerate the ripening of the cheese and/or to intensification of the specific goaty and/or, in particular, of the sheep-like flavour characteristics of the cheese.

A hard cheese produced according to the method of the present invention is preferably produced using a starter culture comprising Streptococcus thermophilus and/or Lactobacillus helveticus.

### The Carboxylic Ester Hydrolase

It is especially preferred that the carboxylic ester hydrolase comprises an esterase. An esterase is an enzyme which is capable of cleaving short chain fatty acids from triglycerides more efficiently than cleaving off long chain fatty acids from triglycerides. Said esterase preferably belongs to class EC 3.1.1.1. Herein “short” preferably relates to C4-C8 and “long” preferably relates to C9 and higher, such as C12-C22.

In a preferred embodiment the carboxylic ester hydrolase further comprises a lipase. A lipase is an enzyme which is capable of cleaving long chain fatty acids from triglycerides more efficiently than cleaving off short chain fatty acids from triglycerides. Said lipase preferably belongs to class EC 3.1.1.3. Herein “short” preferably relates to C4-C8 and “long” preferably relates to C9 and higher, such as C12-C22.

The carboxylic ester hydrolase is most preferably capable of producing C4-C12 fatty acids, especially C4-C8 fatty acids when said carboxylic ester hydrolase is allowed to act on pasteurized full fat milk, which preferably comprises or consists of bovine milk.

The carboxylic ester hydrolase may be provided as an exogenous animal pregastric esterase or as an exogenous lipase or as a mixture thereof. The expression “animal” herein may relate to goat or lamb, especially to kid goat or kid lamb.

In the context of this invention “no added exogenous carboxylic ester hydrolase” preferably means that no lamb and/or goat lipase preparations are included.

### The Lipolytic Yeast Strain

The lipolytic yeast strain is preferably capable of producing C4-C12 fatty acids, preferably C4-C8 fatty acids when said lipolytic yeast strain is allowed to act on pasteurized full fat milk, which preferably comprises or consists of bovine milk.

It is preferred that the lipolytic yeast strain is incapable of utilizing lactose as the only carbon source for its growth or metabolism. Accordingly excessive growth in milk can be prevented, so that the degree of lipolytic activity can be controlled by the dosage of the strain.

A strain of Yarrowia lipolytica has been shown to provide an excellent lipolytic yeast strain as it can provide a cheese with excellent taste and texture, and can be used in suitable and economical amounts whilst being able to control the desired lipolytic activity simply by varying the dosage thereof.

It is therefore particularly preferred that the lipolytic yeast strain is a strain of Yarrowia lipolytica. In a particularly preferred embodiment the lipolytic yeast strain is a strain of Yarrowia lipolytica deposited with BCCM/IHEM under accession number THEM 26011.

The strain of Yarrowia lipolytica is preferably obtained by culturing an inoculum of Yarrowia lipolytica on a suitable medium that contains not more than 1 g glucose per liter followed by harvesting the biomass of Yarrowia lipolytica. The medium preferably comprises whey permeate and/or whey proteins. This ensures appropriate esterase and/or lipase activity per g biomass for the present method.

### The Preferred Ethanol Producing Yeast Strain

The strain of Kluyveromyces preferably is preferably selected from the group consisting of Kluyveromyces lactis and Kluyveromyces marxianus. Accordingly most flavour characteristics typical of a sheep cheese and/or goat cheese can be obtained. The strain of Kluyveromyces is yet more preferably a strain of Kluyveromyces lactis. In a particularly preferred embodiment the strain of Kluyveromyces is a strain of Kluyveromyces lactis which has been deposited with BCCM/IHEM under accession number IHEM 26012.

### The Cheese

In an embodiment, the cheese has a moisture content of 25-60 wt. %, more preferably of 30-45 wt. % relative to the weight of the cheese. The cheese can be a semi-hard or hard cheese. In another embodiment the cheese is a white brined cheese. Regarding white brined cheese, spectacular results were obtained in that cheese was produced according to the invention and using cow's milk only (i.e. without using goat's milk or ewe's milk). After ripening in brine, the taste of the cheese thus produced has been found to closely resemble the taste of a traditional feta produced from 70% ewe's milk and 30% goat's milk. Herein especially the sheep-like notes of the traditional feta cheese were recognized by the tasting panel, but also some goaty notes were remarked.

### Further Aspects of the Invention

In an alternative aspect the invention provides a white brined cheese obtained or obtainable by the present method. The invention particularly provides for a white brined cheese having
one or more flavour characteristics of a sheep cheese and/or of a goat cheese, and
an exogenous carboxylic ester hydrolase or more preferably a lipolytic yeast strain or DNA material originating from and characteristic for said yeast strain, and
an ethanol producing micro-organism which is preferably capable of metabolizing lactose, or DNA material originating from and characteristic for said micro-organism;
   wherein the ethanol producing micro-organism is preferably an ethanol producing yeast strain, and wherein the white brined cheese has been produced using a milk source comprising more than 90% (v/v) of bovine milk and comprising less than 5% (v/v) of each of sheep's milk and goat's milk. Herein most preferably the cheese has been produced using bovine milk as the only milk source.

The invention furthermore provides a composition comprising the white brined cheese which is furthermore in contact with an aqueous solution comprising one or more inorganic salts selected from the group consisting of sodium chloride, calcium chloride and potassium chloride, wherein the total concentration of said one or more inorganic salts in the aqueous solution ranges between 1-25 wt. % relative to the weight of the aqueous solution, preferably between 3-12% relative to the weight of the aqueous solution. In said composition, a weight ratio w can be defined as the weight of the white brined cheese divided by the weight of the aqueous solution comprising one or more inorganic salts selected from the group consisting of sodium chloride, calcium chloride and potassium chloride, wherein the weight ratio w preferably ranges between 100 and 0.1, more preferably between 10 and 0.2.

The invention further provides a white brined cheese obtained according to the present method and preferably comprising
a strain of Yarrowia lipolytica or DNA material originating from and characteristic for said yeast strain,
and an ethanol producing micro-organism, preferably an ethanol producing yeast strain, which is further preferably capable of metabolizing lactose, or DNA material originating from and characteristic for said micro-organism, especially from and characteristic for said yeast strain,
wherein the cheese has been produced using a milk source comprising one or more milk types selected from the group consisting of bovine milk having a fat content, goat's milk having a fat content and ewe's milk having a fat content. Herein the milk source preferably comprises bovine milk having a fat content.

It is especially preferred that the cheese has been produced using a milk source comprising more than 90% (v/v), more preferably more than 95% (v/v) most preferably more than 99% (v/v) of bovine milk and comprising less than 5% (v/v) more preferably less than 1% (v/v) such as about 0% (v/v) of each of sheep's milk and goat's milk. Alternatively or more preferably the cheese preferably comprises no exogenous carboxylic ester hydrolase, especially no goat lipase and/or no lamb lipase. The white brined cheese preferably has one or more flavour characteristics of a sheep cheese or a goat cheese, more preferably has one or more flavour characteristics of a traditional feta cheese made of ewe's milk or of a mixture of ewe's milk and goat's milk.

### The Yeast Culture Composition

The yeast culture composition preferably is in a form suitable to be employed in commercial scale cheese making processes.

The yeast culture composition may be provided as a single composition preferably packaged in a single container. The yeast culture composition may alternatively be provided as a kit-of-parts wherein component (i.) and (ii.) are preferably provided in separate containers with instructions to use together in a cheese making process.

The weight of the yeast culture composition is preferably at least 25 g, more preferably at least 50 g. Preferably the weight of the yeast culture composition is at most 500 kg, more preferably at most 250 kg. Preferably the weight of the yeast culture composition ranges from 50 g to 25 kg, preferably from 100 g to 10 kg.

In the yeast culture composition, the lipolytic yeast strain preferably is a strain of Yarrowia lipolytica and the ethanol producing micro-organism preferably is a strain of Kluyveromyces.

The invention thus preferably provides a frozen or dried yeast culture composition having a weight of at least 10 g, preferably contained in a closed container comprising
(i.) a strain of Yarrowia lipolytica; and
(ii.) a strain of Kluyveromyces,
   wherein the strain of Yarrowia hpolytica and the strain of Kluyveromyces each are present in a total amount of 1.10⁸ cfu or higher, more preferably in a total amount of 1.10⁹ cfu or higher, per gram of the yeast culture composition; and
   wherein a ratio ry can be defined as the total number of colony forming units of the Yarrowia hpolytica strain divided by the total number of colony forming units of the Kluyveromyces strain, wherein said ratio ry is preferably greater than 1:6, more preferably greater than 1:4, most preferably greater than 1:2. Further preferably said ratio ry is lower than 10:1, more preferably lower than 6:1, more preferably lower than 4:1, most preferably lower than 2:1, wherein preferably the composition comprises no added exogenous carboxylic ester hydrolase.

The strain of Kluyveromyces herein preferably is a strain of Kluyveromyces lactis or a strain of Kluyveromyces marxianus or a mixture thereof, and most preferably is a strain of Kluyveromyces lactis deposited with BCCM/IHEM under accession number IHEM 26012.The strain of Yarrowia hpolytica preferably is a strain of Yarrowia hpolytica deposited with BCCM/IHEM under accession number IHEM 26011.

In a preferred embodiment the yeast culture composition is frozen. In one embodiment, the yeast culture composition is in the form of frozen pellets.

The dried or frozen yeast culture composition preferably further comprises a cryoprotectant, preferably in a concentration of 1-15 g per gram yeast culture composition. Preferably the cryoprotectant comprises a disaccharide.

The yeast culture composition may optionally comprise a strain of Hafnia alvei with the proviso that the cell count density of the strain of Hafnia alvei preferably does not exceed the total cell count density of Kluyveromyces, especially of Kluyveromyces lactis. It is especially preferred that if present, the cell count density of the strain of Hafnia alvei does not exceed the total cell count density of Kluyveromyces, especially of Kluyveromyces lactis, by a factor of 2, more preferably by a factor of 5 or most preferably by a factor of 10. Further preferably the yeast culture composition contains no or substantially no Hafnia alvei.

Preferably the yeast culture composition comprises no propionibacteria at a viable cell count density exceeding 1.10⁶ cfu, preferably 10⁴ cfu per g of the yeast culture composition. Preferably propionibacteria are absent in the yeast culture composition.

### Further Embodiments

In a preferred embodiment of the method of producing a white brined cheese, the milk is further mixed with a bleaching agent, preferably a chlorophyll. This is especially preferred if the milk comprises bovine milk, especially cow's milk. Whilst the use of bovine milk, especially cow's milk, may, depending on the concentration thereof and seasonal influences, provide the cheese with a yellowish hue, the addition of a bleaching agent helps to ensure a desired white colour of the cheese.

What is describe here above for the yeast culture composition, also applies to the yeast culture composition when it is in the form of a kit-of-parts.

### EXAMPLES

### Materials and Methods

O700 is a starter culture that is commercially available ex CSK Food Enrichment BV, The Netherlands. This starter culture contains only lactococci and is a so-called O-culture. Total viable cell count of Lactococcus lactis for the present batch was 8.6E10 cfu/g as determined on a beta-glycerophosphate milk agar (GMA).

L200 and L600 are adjunct cultures comprising thermophilic lactobacilli, especially strains of Lactobacillus helveticus. Both cultures are commercially available ex CSK Food Enrichment BV, The Netherlands. Total cell count of lactobacilli in the present batch of L200 was approx. 3 E5 cfu/g as determined on TGV; total cell count of lactobacilli in L600 was approx 5 E10 cfu/g.

TGV agar comprises 1% (m/v) trypton; 0.3% (m/v) meat extract; 0.5% (m/v) yeast extract; 4% (v/v) tomato juice; 0.1% (v/v) Tween-80; 0.2% (m/v) of K₂HPO₄ and 4.5% (m/v) glucose.

O700, L200, and L600 are each provided in the form of frozen pellets.

In this study a frozen culture of Y. lipolytica CSK1795 was used; this culture was obtained by growing the strain on a whey-based medium in the absence of added glucose (said medium contained only milk, whey permeate, yeast extract, minerals and phosphate buffer). After concentrating the culture was frozen as droplets in liquid nitrogen to obtain frozen pellets having a cell count of 3.10⁹ cfu/g on OGYE agar (Difco Cat. No. 218111). It is separately noted that Y. lipolytica can ferment glucose but cannot substantially use lactose for its metabolism, so that it is expected that the microorganism used its nitrogen metabolism to grow on said medium. It is further noted that less optimal results in terms of (lipolytic) activity in the cheese were obtained if substantial amounts of glucose were added to the growth medium.

In this study a frozen culture of Kluyveromyces lactis strain CSK1407 was used; this culture was obtained by growing the strain on a whey permeate medium and in the absence of added glucose (said medium contained only milk, whey permeate, yeast extract, minerals and phosphate buffer). After concentrating the culture was frozen as droplets in liquid nitrogen to obtain frozen pellets having a cell count of 2.10⁹ cfu/g on OGYE agar (Difco Cat. No. 218111).

Instead of strain CSK1407, it is also possible to use X400. X400 is a culture of Kluyveromyces lactis, provided in the form of frozen pellets, and commercially available ex CSK Food Enrichment BV, The Netherlands. The viable cell count of this culture is 2.10⁹ cfu/g on OGYE agar (Difco Cat. No. 218111).

### Protocol for Producing White Brined Cheese:

Take full-fat pasteurized milk (conveniently obtained from a supermarket and comprising a natural lactose content) and measure the pH
Fill 5× 500 mL centrifuge buckets for each variant with 475 ml milk and place in a water bath of 35° C.
Add 0.10 mL CaCl2 solution (33 wt. %, commercially supplied e.g. by CSK Food

Enrichment BV, The Netherlands) and add the starter culture (O700) and any other desired microbial culture(s).
Gently stir the mixture for 1 minute
Leave the bucket for 15 min. keeping the water bath at 35° C.
Add 0.10 mL calf rennet (Kalase® 220 IMCU, supplied by CSK Food Enrichment BV, The Netherlands)
Gently stir the mixture for 1 minute
Leave the bucket for 50 min. Keep the water bath at 35° C.
Cut the curd obtained with a knife in particles of about 1×1×1 cm
Put the lid on the bucket and centrifuge for 10 minutes at 2000 rpm and 20° C.
Decant the whey and transfer the cheese from the bucket into a sterilized glass beaker; seal the beaker containing the cheese with parafilm.
Store the cheese in the beaker for ±16-18 hours at 21° C. After the pH has reached a value of less than 4.7, cool the cheese down to 5° C.
Place the cheese in a sterilised NaCl solution having a NaCl concentration of 6 wt % relative to the total weight of the solution, and store at 5° C. for 18 hours.
After 18 hours take the cheese out of the brine solution. Before consumption store it in a vacumized plastic foil bag at 5° C.°

The cheeses produced according to the invention and the control cheeses were evaluated by a tasting panel of 6-10 persons. The members of the test panel were all skilled in tasting cheese. The panel was trained to recognize typical flavour characteristics of a traditional feta cheese made of goat's milk and ewe's milk (approx. 30/70 ratio) brand “Eridanous”. In Experiments A-H below, the panel was asked to rate white brined cheese made exclusively of pasteurized full fat cow's milk as “typical feta,” referring to the specific flavour of the traditional feta. Samples were evaluated for tasting not, a little, moderately, a lot like sheep/goat feta and even exceeding the taste of sheep/goat feta (visual/analog score). Generally, white brined cheese produced according to the invention had a higher typical feta score than a white brined cheese produced from full fat cow's milk and using O700 only and which was provided as blind control (ANOVA test, 95% confidence interval). Detailed results are provided below.

### 1. White Brined Cheese

A. White brined cheeses were produced on lab scale with pasteurized full fat cow's milk from Campina. The milk was acidified with the O-culture O700 (0.10 g/l). Kid goat lipase powder (Ditta Calza Clemente Srl, Italy) was added to the milk in a dosage of 30 mg lipase powder per litre of milk. The cheese had a bland flavour with some soapy notes. The tasting panel rated the cheese to taste a little like sheep/goat feta due to some soapy notes, but the complexity of the flavour profile of the sheep/goat feta especially its fruity notes were not achieved.

B. As experiment A but instead of kid goat lipase powder, the yeast strain Y. lipolytica CSK1795 was added as a pelletized frozen culture in a concentration of 0.10 g/l, which results in a cell count of 4E5 milk. The tasting panel rated the cheese to moderately like sheep/goat feta. The flavour of the cheese was more pleasant and complex than the flavour of the cheese produced in A, but the typical fruity notes of a traditional sheep/goat feta were still not achieved.

C. White brined cheeses were produced on lab scale with pasteurized full fat cow's milk from Campina. The milk was acidified with the O-culture O700 (0.10 g/l). The yeast strains Y. lipolytica CSK1795 and K. lactis CSK1407 were added as frozen pelletized cultures in a concentration of 0.10 g/l, which results in a cell count of 4E5 and 2E5 cfu/ml milk, respectively. The flavour characteristics of this white brined cheese produced using cow's milk only (i.e. without using goat's milk or ewe's milk) was found to closely resemble those of a traditional feta produced from 70% ewe's milk and 30% goat's milk. The tasting panel rated the cheese to taste a lot like sheep/goat feta. Herein especially the sheep-like notes of the traditional feta cheese were recognized by the tasting panel, but also some goaty notes were remarked.

As a control experiment a white brined cheese was produced from pasteurized full fat cow's milk in the presence of O700 but in the absence of the strains of Yarrowia hpolytica and Kluyveromyces lactis. The sensory evaluation revealed that this cheese had a bland flavour not at all reminiscent of goaty or sheep-like flavour.

D. In yet another control experiment, the combination of the strains of Yarrowia hpolytica and Kluyveromyces lactis described above in experiment C was employed to produce a white brined cheese from skimmed milk. No further difference was made in the set-up or evaluation as compared with experiment C. The tasting panel rated the cheese not to taste like sheep/goat feta. No sheep-like or goaty notes were obtained, indicating that the presence of fat in the milk is essential.

E. In a further control experiment, K. lactis CSK1407, was added to the same milk as in experiment A further comprising O700 in the same dosage as in experiment A but without the added kid goat lipase. No further difference was made in the set-up or evaluation as compared with experiment A. In the presence of K. lactis CSK1407 only, the cheese had a not unpleasant yet atypical fruity/yeasty flavour.

F. In further experiments involving combinations of Yarrowia hpolytica and K. lactis CSK1407, Y. lipolytica CSK1795 was replaced by other strains of Yarrowia hpolytica. No further difference was made in the set-up or evaluation as compared with experiment C. The sheep-like and goat-like flavours found in experiment C were generally reproduced, albeit to a lesser extent. On average the tasting panel rated the cheeses to have a moderately strong sheep/goat feta taste.

G. In yet further experiments involving combinations with K. lactis CSK1407, the strain Y. lipolytica CSK1795 was replaced by an exogenous carboxylic ester hydrolase. No further difference was made in the set-up or evaluation as compared with experiment C. Kid goat lipase powder (Ditta Calza Clemente Srl, Italy) was added to the milk in a dosage of 30 mg lipase powder per litre of milk. The tasting panel rated the cheese to taste moderately like sheep/goat feta. Goat-like and sheep-like flavours were obtained but at a lower intensity than if a strain of Yarrowia hpolytica was used.

H. The experiment under C was repeated, wherein instead of cow's milk, full fat pasteurized goat's milk was employed. In the presence of the yeast strains Y. lipolytica CSK1795 and K. lactis CSK1407, the goaty flavour was enhanced as compared to a control cheese produced using O700 only. The tasting panel rated the cheese to exceed the taste of the pure goat feta.

### 2. Semi-Hard Cheese Produced According to a Gouda Protocol

The following example demonstrates that the flavour characteristics of a semi-hard cheese produced according to the invention and using cow's milk only (i.e. without using goat's milk or ewe's milk) have been found to closely resemble those of a semi-hard cheese at least partially produced from ewe's milk and/or goat's milk.

### Cheese Production Characteristics

Gouda-type of cheese was produced with a defined mixed strain starter O700 that contains only Lactococcus species (reference, vat 1). Two additional vats were produced with the following adjunct cultures (O700 being used as acidifying culture and not further listed below):

vat 2: 150 gram L200+150 gram L600+150 gram Y. lipolytica CSK1795
vat 3: 200 gram L200+100 gram K. lactis CSK1407+150 gram Y. lipolytica CSK1795
(dosage to 1500 litres of milk)

The cheeses were produced, brined and ripened as 12 kg cheese wheels according to a conventional protocol for Gouda cheese using full fat pasteurised cow's milk having a natural lactose content. Calf rennet (Kalase at 150 IMCU) was used as coagulant; ripening took place with application of a polyvinylacetate-based plastic coating (CeskaCoat® ex CSK Food Enrichment, The Netherlands) at regular intervals and at a temperature of 12-14° C. and a relative humidity of 82-86%. The amount of yeast cells added to the cheese milk was for Y. lipolytica 3.0E5 cfu/ml and for K. lactis 1.3E5 cfu/ml. The chemical composition after 14 weeks of ripening was comparable for all three type of cheeses (results not shown).

### Cheese Evaluation

The cheeses were evaluated at 6 weeks after production by a trained tasting panel. The cheese produced in vat 1 had a flat taste. The cheese in vat 2 was perceived as soapy, although the combination of Y. lipolytica with Lactobacillus strains (L200 +L600) did improve the acceptance of the soapy flavor as compared with the single use of Y. lipolytica (without further addition of lactobacilli) in an earlier cheese trial. The combination of Y. lipolytica with K. lactis resulted in a flavor that was recognized as a goaty and sheepy flavor.

### Further trials

Likewise, the following cheeses were produced in a similar way. Cheese was produced from full fat pasteurised cow's milk having a natural lactose content, with a defined mixed strain starter O700 that contains only Lactococcus species (reference, vat 1). Two additional vats were produced with the following adjunct cultures (O700 being used as acidifying culture and not further listed below):

vat 2: 150 gram Y. lipolytica CSK1795
vat 3: 150 gram K. lactis CSK1407
vat 4: 150 gram K. lactis CSK1407+150 gram Y. lipolytica CSK1795
(dosage to 1500 litres of milk)

The cheeses produced with Y. lipolytica scored significantly higher on soapy irrespectively of the presence of K. lactis. In the presence of K. lactis the cheeses scored higher on fruity. Only in the presence of Y. lipolytica and of K. lactis, most typical flavours of a goat cheese and a sheep cheese were observed.

1. A method for producing cheese, comprising mixing milk with a coagulant, a starter culture, an exogenous carboxylic ester hydrolase, and an ethanol producing yeast strain, to obtain a cheese, wherein the milk comprises bovine milk, goat milk and/or ewe milk.

2. The method according to claim 1, wherein the milk predominantly comprises bovine milk.

3. The method according to claim 1, wherein the milk has a lactose content of between 0.5-10 wt. % relative to the weight of the milk.

4. The method according to claim 1, wherein the ethanol producing yeast strain is capable of metabolising lactose.

5. The method according to claim 1, wherein the ethanol producing yeast strain is a strain of Kluyveromyces.

6. The method according to claim 1, wherein the exogenous carboxylic ester hydrolase is capable of producing C4-C12 fatty acids when allowed to act on pasteurized full fat bovine milk.

7. The method according to claim 1, wherein the exogenous carboxylic ester hydrolase is capable of producing C4-C8 fatty acids when allowed to act on pasteurized full fat bovine milk.

8. The method according to claim 1, further comprising ripening the cheese.

9. The method according to claim 1, wherein the cheese is a white brined cheese.

10. A method for accelerating the ripening of cheese and/or enhancing the flavor characteristics of cheese, comprising mixing milk with a coagulant, a starter culture, an exogenous carboxylic ester hydrolase, and an ethanol producing yeast strain, to obtain a cheese, wherein the milk comprises bovine milk, goat milk, and/or ewe milk.

11. The method according to claim 10, wherein the ethanol producing yeast strain is capable of metabolising lactose.

12. The method according to claim 10, wherein the ethanol producing yeast strain is a strain of Kluyveromyces.

13. The method according to claim 10, wherein the exogenous carboxylic ester hydrolase is capable of producing C4-C12 fatty acids when allowed to act on pasteurized full fat bovine milk.

14. The method according to claim 10, wherein the exogenous carboxylic ester hydrolase is capable of producing C4-C8 fatty acids when allowed to act on pasteurized full fat bovine milk.

15. The method according to claim 10, wherein the cheese is a white brined cheese.

16. A frozen or dried yeast culture, comprising:
(i) an exogenous carboxylic ester hydrolase; and
(ii) an ethanol producing yeast strain.

17. The yeast culture according to claim 16, wherein the ethanol producing yeast strain is capable of metabolizing lactose.

18. The yeast culture according to claim 16, wherein the ethanol producing yeast strain is capable of metabolising lactose.

19. The yeast culture according to claim 16, wherein the ethanol producing yeast strain is a strain of Kluyveromyces.

20. The yeast culture according to claim 16, wherein the exogenous carboxylic ester hydrolase is capable of producing C4-C12 fatty acids when allowed to act on pasteurized full fat bovine milk.

21. The yeast culture according to claim 16, wherein the exogenous carboxylic ester hydrolase is capable of producing C4-C8 fatty acids when allowed to act on pasteurized full fat bovine milk.

22. The yeast culture according to claim 16 , wherein components (i.) and (ii.) are provided in such amounts and/or having such activities that the yeast culture composition is suitable for generating, in a cheese made exclusively of bovine milk having a lactose content and a fat content, one or more flavor characteristics of a sheep cheese or a goat cheese.

23. A white brined cheese obtainable by the method according to claim 1.
